(19) United States
(12) Patent Application Publication
(10) Pub. No.: US 2024/0104537 A1
(43) Pub. Date: Mar. 28, 2024

(54) SYSTEMS AND METHODS FOR THIRD-PARTY SHOPPER EXIT VERIFICATION

(71) Applicant: Walmart Apollo, LLC, Bentonville, AR (US)

(72) Inventors: Pratik I. Khandelwal, Jersey City, NJ (US); Anantha Raman Lakshmi Narayanan, Bentonville, AR (US); Malori J. Miller, Fayetteville, AR (US); Shashishekhar Prasad, Bentonville, AR (US); Guruprasad Subbarao, Aldie, VA (US); Tyler W. Rutledge, Bentonville, AR (US); Gnanapriya Venkatasubramaniam, San Carlos, CA (US); Mayank Aggarwal, Bentonville, AR (US); Periyar Selvam Jagadeesan, Bentonville, AR (US); Karthikeyan Jayapal, Dublin, CA (US); Sonia Salahuddin, Sacramento, CA (US); Dinoop Dayanand, Cupertino, CA (US)

(21) Appl. No.: 17/954,213

(22) Filed: Sep. 27, 2022

(51) Int. Cl. G06Q 20/20; G06Q 30/06

(52) U.S. Cl. CPC G06Q 20/206; G06Q 30/0633

(57) ABSTRACT

A system for third-party shopper exit verification is provided. The system includes a store user device, a network interface, a third-party shopper database, and a central computer system. The central computer is configured to provide, to a third-party shopper device, items in a customer order to be collected by a third-party shopper from a retail store; detect a completion of a shopping trip for the customer order; retrieve third-party shopper information associated with the third-party shopper from the third-party shopper database; and determine whether to initiate an audit process based at least on the third-party shopper information. In the event that the audit process is required, the central computer system causes an audit request to display on the store user device and determines whether the third-party shopper passes audit based on comparing item identifiers of items in possession of the third-party shopper with items in the customer order.

### TECHNICAL FIELD

This invention relates generally to retail store systems, and particularly to retail store systems for third-party shopper exit verification.

### BACKGROUND

Online personal shopper platforms provide personal shopper services to customers of the platform. When a customer places an order through the platform, a personal shopper goes to a store to collect and purchase the items for the customer and delivers the items to the customer.

### BRIEF DESCRIPTION OF THE DRAWINGS

Disclosed herein are embodiments of systems and methods for third-party shopper exit verification. This description includes drawings, wherein:

FIG. 1 comprises a block diagram of a system in accordance with some embodiments;

FIG. 2 comprises a flow diagram of a method in accordance with some embodiments;

FIGS. 3A and 3B comprise a flow diagram of an exit process in accordance with some embodiments;

FIGS. 4A and 4B comprise a process diagram of an exit process with push notification in accordance with some embodiments;

FIGS. 5A and 5B comprise a process diagram of an exit process in accordance with some embodiments;

FIGS. 6A-6G comprise illustrations of user interface displays of a third-party shopper application in accordance with some embodiments;

FIGS. 7A-7F comprise illustrations of user interface displays of a third-party shopper application in accordance with some embodiments;

FIGS. 8A-8B comprise illustrations of user interface displays of a third-party shopper application in accordance with some embodiments; and

FIGS. 9A-9C comprise illustrations of user interface displays of a third-party shopper application in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally speaking, pursuant to various embodiments, systems, devices, and methods are provided for third-party shopper exit verification. In some embodiments, a system for third-party shopper exit verification comprises a store user device, a network interface, a third-party shopper database, and a central computer system. The central computer system comprising a control circuit configured to provide, via the network interface to a third-party shopper device of a third-party shopper executing a third-party shopper application, items in a customer order to be collected by a third-party shopper from a retail store; detect a completion of a shopping trip for the customer order; retrieve third-party shopper information associated with the third-party shopper from the third-party shopper database; and determine whether to initiate an audit process based at least on the third-party shopper information. In the event that the audit process is required, the control circuit is configured to cause an audit request to display on the store user device and determine whether the third-party shopper passes the audit process based on comparing item identifiers of items in possession of the third-party shopper with items in the customer order. In the event that the audit process is not required or the third-party shopper passes the audit process, the control circuit is configured to cause an exit instruction to be displayed on the third-party shopper device.

As used herein, a third-party shopper generally refers to a person providing third-party shopper service to a customer. The third-party shopper may receive a list of items for purchase by the customer. The third-party shopper then goes to a retail store, collect the items on the list, and delivers the items to the customer at a customer-selected location.

Conventionally, a personal shopper working for a personal shopper platform (e.g. Instacart, Uber Eats) carries a payment card provided by the platform. To exit the store, the personal shopper would go through the manned or self-checkout terminal just as a regular customer, using the payment card of the platform. In such systems, the retail store does not differentiate between regular customers and personal shoppers shopping for the actual customer.

In some embodiments described herein, a customer places a third-party shopper order with the retail entity. The customer makes payment to the retail entity operating the retail store through an online ordering user interface or pre-authorizes a charge to the retail entity for the order. As such, the third-party shopper does not make payment for the customer order at the retail store. Because a third-party shopper does not go through the typical checkout process before exiting the retail location as a store customer, a new system and process are provided to improve the store retail store infrastructure for third-party shopper verification. In some embodiments, the present disclosure provides an improved point of sale (POS) infrastructure of a retail store that reduces the friction for third-party shopper exit verification.

In some embodiments, a third-party shopper application is provided that allows third-party shoppers to complete their shopping trip by using the Self Check Out terminals (SCO) in stores. A third-party shopper can scan a QR code at the SCO and follow the prompts. The system will inform them if an audit is required and will present an exit screen which they may display to the exit checker in the store.

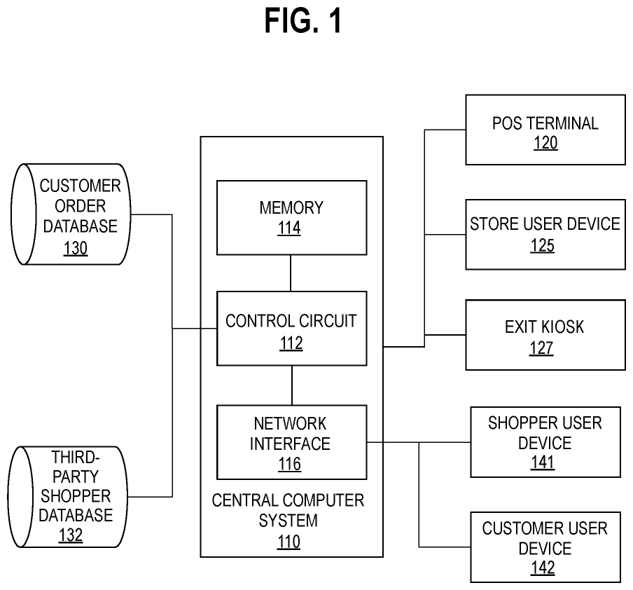

Referring now to FIG. 1, a system for third-party shopper exit verification is shown. The central computer system 110 is coupled to a customer order database 130, a third-party shopper database 132, a POS terminal 120, a store user device 125, an exit device 127, a third-party shopper user device 141, and a customer user device 142.

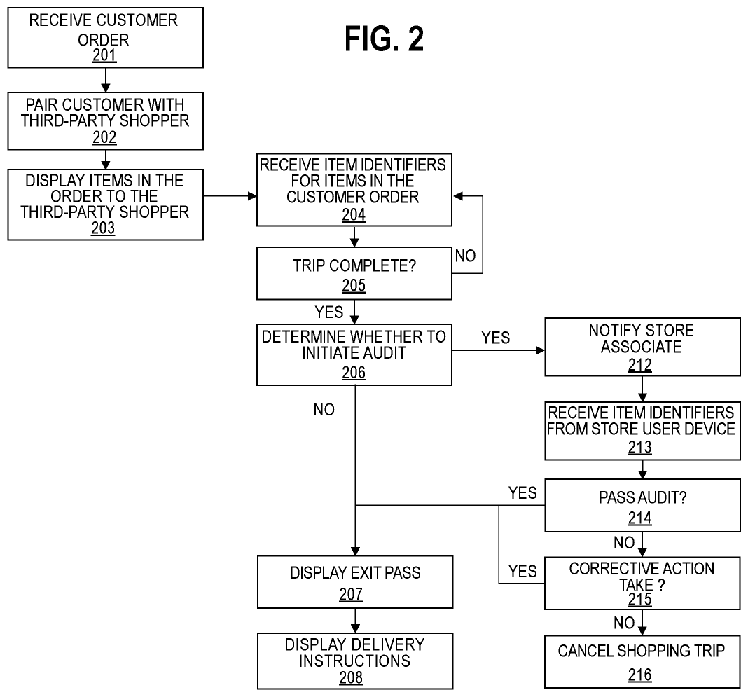

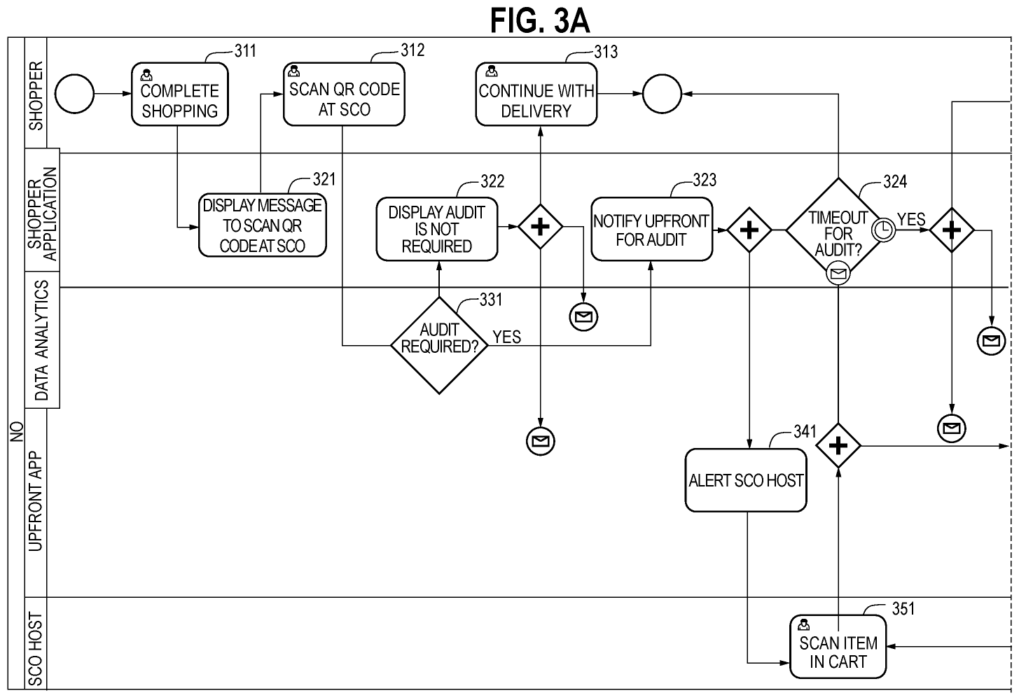

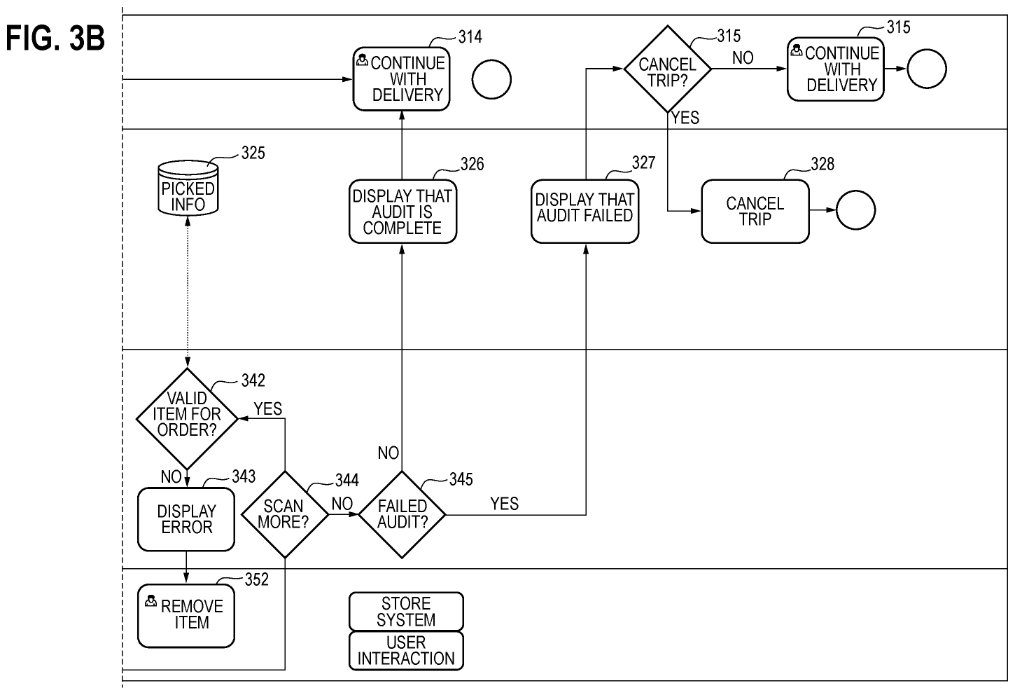

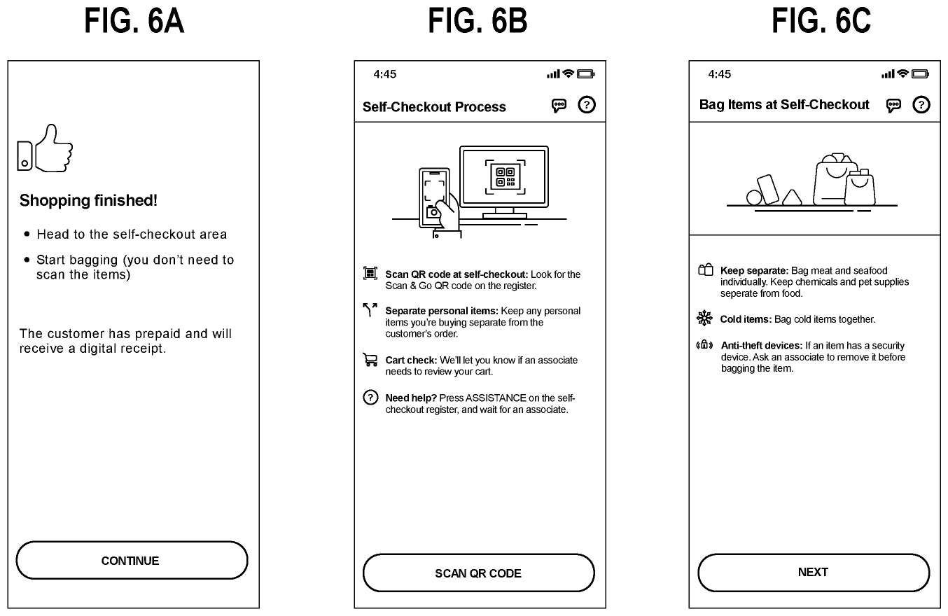

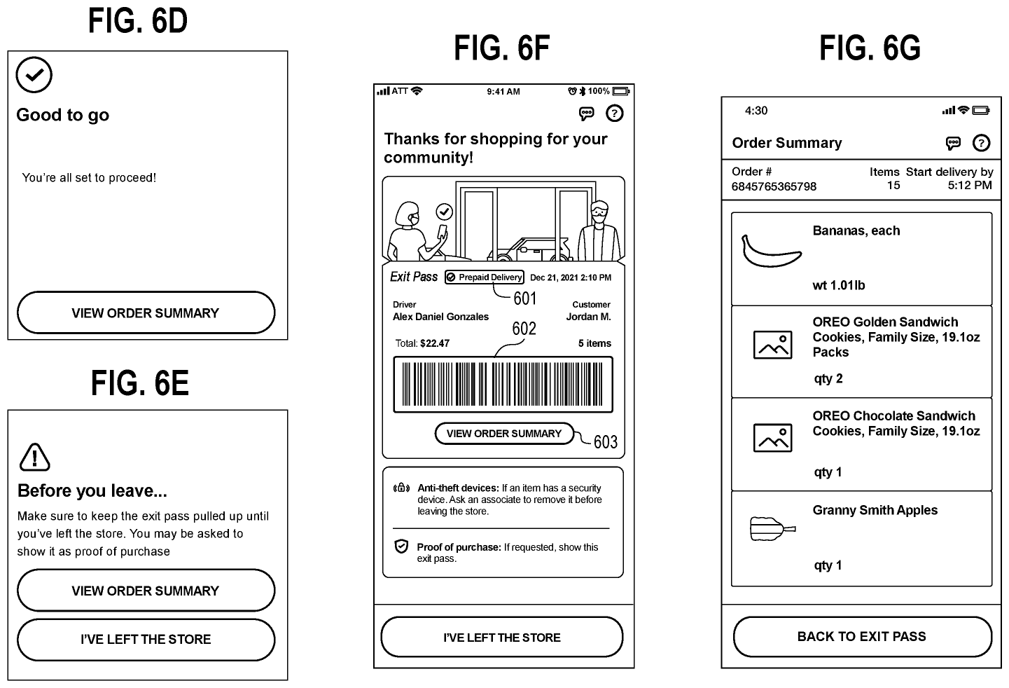

The central computer system 110 comprises a control circuit 112, a memory 114, and a network interface device 116. The central computer system 110 may comprise one or more of a server, a retailer backend system, a central computing system, an application server, a cloud-based server system, and the like. In some embodiments, the central computer system 110 may be implemented by a plurality of physically separated processor-based devices. In some embodiments, the central computer system 110 may further communicate with other services/data providers such as a data analytics service, a product information database, etc. The control circuit 112 may comprise a processor, a microprocessor, a central processing unit (CPU), a graphics processing unit (GPU), an application-specific integrated circuit (ASIC), and the like and may be configured to execute computer-readable instructions stored on a computer-readable storage memory 114. The computer-readable storage memory 114 may comprise volatile and/or non-volatile memory and have stored upon it, a set of computer-readable instructions which, when executed by the control circuit 112, causes the central computer system 110 to facilitate third-party exit verification between one or more of the POS terminal 120, the store user device 125, the exit device 127, and the third-party shopper user device 141 based on information stored in the customer order database 130 and the third-party shopper database 132. In some embodiments, the computer-executable instructions may cause the control circuit 112 of the central computer system 110 to perform one or more steps described with reference to FIGS. 2, 3A-B, 4A-B, and 5A-B herein. In some embodiments, the computer-executable instructions may cause the control circuit 112 of the central computer system 110 to provide a third-party shopper user interface, such as the graphical user interfaces described with reference to FIGS. 6A-6G, 7A-7D, 8A-8B, and 9A-9B. In some embodiments, the memory 114 may further store one or more of the customer order database 130 and third-party shopper database 132.

The network interface device 116 may comprise a data port, a wired or wireless network adapter, and the like. In some embodiments, the central computer system 110 may communicate with the third-party shopper user device 141 and the customer user device 142 over a network such as the Internet. The customer user device 142 generally refers to the user device used by a customer placing a third-party shopper order. In some embodiments, the customer user device 142 may be a processor-based standalone user device such as a personal computer, a desktop computer, a laptop computer, a mobile device, a smartphone, and the like. The customer user device 142 may comprise user input/output devices such as a keyboard, a mouse, a touch screen, a display screen, a VR/AR display device, a speaker, a microphone, etc. The customer user device 142 may execute an application for displaying a customer shopping user interface for placing third-party shopper orders. For example, the customer user device 142 may comprise a mobile phone running an e-commerce application supported by the central computer system 110 that offers third-party shoppers as a delivery method for ordered items. A customer may use the customer user device 142 to add, modify, and remove a list of items for purchase and provide a payment method for the order. The customer order details are then stored in the customer order database 130. In some embodiments, the customer user interface may further display communications and updates from the third-party shopper (e.g. “the shopper is at the store,” items picked, “the shopper has checked out,” “the shopper will arrive in x minutes.”).

The shopper user device 141 generally refers to the user device used by a third-party shopper providing third-party shopper service to a customer. In some embodiments, the shopper user device 141 may be a processor-based standalone user device such as a mobile device, a smartphone, a wearable device, and the like. The shopper user device 141 may comprise user input/output devices such as a keyboard, a mouse, a touch screen, a display screen, a VR/AR display device, a camera, a speaker, a microphone, etc. The shopper user device 141 may execute an application for displaying a third-party shopper user interface for accepting and performing third-party shopper services. For example, the shopper user device 141 may comprise a mobile phone running a third-party shopper application supported by the central computer system 110 that allows the shopper to view available orders, accept and order, and view order details. While at a store location, a shopper may use the shopper user device 141 to scan picked items and/or indicate that certain items are unavailable/out of stock. In some embodiments, the shopper application may further provide an interface for messaging the customer. When the items are picked, the shopper application provides instructions for exiting the store as described herein. The shopper application may further provide delivery instructions for the shopper to deliver the items from the retail store to the customer's selected location.

The POS terminal 120 may comprise an in-store checkout terminal for processing purchase transactions. In some embodiments, the POS terminal 120 may comprise a self-service POS system. The POS terminal 120 may comprise one or more of an optical scanner, a display screen, a weight scale, a bagging area, a receipt printer, etc. In some embodiments, the POS terminal 120 may comprise conventional components of a checkout terminal configured to identify items brought to the terminal for purchase transactions by in-store customers. In some embodiments, the POS terminal 120 may further be configured to provide a POS identifier, a store identifier, and/or transaction identifier to the store user device 125 by displaying an image (e.g. QR code, barcode) or transmitting a wireless signal, such that the shopper user device 141 may capture the QR code to initiate the exit verification process. Alternatively, the shopper user device 141 may provide a user account identifier by displaying an image for scanning by the POS or transmitting a wireless signal to the POS. The POS terminal 120 may then transmit the user account identifier to the central computer system 110 for exit verification. In some embodiments, the POS terminal 120 may display exit instructions in place of or in addition to the information displayed on the shopper user device 141. In some embodiments, the POS terminal may include an optical code scanner for obtaining the item identifiers of items in possession of the third-party shopper to be used by a store associate for scanning items during audits of third-party shoppers.

The store user device 125 generally refers to the user device used by a store employee in a retail store. In some embodiments, the store user device 125 may be a processor-based standalone user device such as a personal computer, a desktop computer, a laptop computer, a mobile device, a smartphone, and the like. The store user device 125 may comprise user input/output devices such as a keyboard, a mouse, a touch screen, a display screen, a VR/AR display device, a speaker, a microphone, etc. The store user device 125 may execute a store upfront application for displaying various information and notifications to store associates. In some embodiments, the store user device 125 displays an audit notification when a third-party shopper is selected for audit. The store associate may use the store user device 125 to accept the audit task and/or scan items in the possession of the shopper to perform the audit. In some embodiments, the store user device 125 may comprise a handheld device with an optical code scanner for scanning item identifiers (e.g. UPC, GTIN).

The exit device 127 generally refers to a device located near the exit of the store that is used to verify whether a shopper is approved to exit with the content of their shopping cart or basket. In some embodiments, the exit device 127 comprises an optical scanner for scanning a barcode of an exit pass displayed on the shopper user device 141 and/or printed on a receipt. The exit device 127 may provide the scanned exit pass identifier to the central computer system 110 which will then determine whether the exit pass presented by the shopper is valid. In some embodiments, the exit device 127 further comprises a visual indicator (e.g. display screen, indicator light) for indicating whether the exit pass is valid to store associates. In some embodiments, the exit device 127 may comprise a store user device 125 operated by a store associate. For example, an associate may use a handheld scanner to check the exit passes of shoppers exiting the store. In some embodiments, the exit device 127 may comprise an electronic kiosk.

While one of each of a POS terminal 120, a store user device 125, an exit device 127, a shopper user device 141, and a customer user device 142 is shown in FIG. 1, the central computer system 110 may communicate with a plurality of each of these devices to update the contents of the customer order database 130 and third-party shopper database 132 and verify third-party shopper exit requests.

The customer order database 130 comprises computer-readable memory storage storing orders placed by customers through customer user devices 142. In some embodiments, the customer orders in the customer order database 130 may include a list of items to be picked in the retail store, costs of the items, customer name, and delivery location. In some embodiments, when a third-party shopper accepts a customer order, the third-party shopper's identifier may also be added to the customer order database 130. In some embodiments, the customer order database 130 may further be updated with the status of the order (e.g. accepted by driver, being picked, on the way, completed) as the order progresses.

The third-party shopper database 132 comprises computer-readable memory storage storing histories of third-party shoppers registered with the system. In some embodiments, each third-party shopper account may record the number of completed orders, the cost of each completed order, and past audit results (pass/fail). the length of the shopper account, customer ratings of the third-party shopper, etc. In some embodiments, each customer order accepted and/or completed by each third-party shopper may be recorded. The information stored in the third-party shopper database 132 may be used by the central computer system 110 to determine whether an audit should be initiated for a third-party shopper. In some embodiments, the information stored in the third-party shopper database 132 may be provided to a data analytics and predictive intelligence service and combined with data from other sources to determine whether an audit should be required for a shopper.

In some embodiments, the central computer system 110 may further be coupled to other retail and/or e-commerce backends such as an inventory system, a payment processing system, and an order fulfillment system for processing and fulfilling customer orders.

Referring now to FIG. 2, a method for third-party shopper exit verification is shown. In some embodiments, the steps shown in FIG. 2 may be performed by a processor-based device such as a control circuit executing a set of computer-readable instructions stored on a computer-readable memory. In some embodiments, one or more steps of FIG. 2 may be performed by the central computer system 110 described with reference to FIG. 1 or other similar devices.

In step 201, the system receives a customer order to be fulfilled by a third-party shopper. The customer order includes a list of items to be picked from a local retail store location and delivered to the customer's selected location (e.g. home). In some embodiments, the customer order is a pre-paid or pre-authorized payment order, and the customer order includes a payment method (e.g. credit card, gift card, charge account, etc.). In some embodiments, the items in the list may be selected in an e-commerce user interface such as an e-commerce mobile application or a e-commerce website. In some embodiments, the customer may be offered a variety of delivery methods (e.g. pickup in-store, pickup cub side, shipped, or third-party shopper delivery) via the e-commerce application/website.

In step 202, the customer order is paired with a third-party shopper. In some embodiments, customer orders may be offered to one or more third-party shoppers signed into the system via a third-party shopper application. In some embodiments, the third-party shopper may be shown details of the order (e.g. delivery address, order total) and be offered the option of accepting the customer order.

Once an order is assigned to a shopper, in step 203, the system provides items in a customer order to be collected by a third-party shopper from a retail store a third-party shopper device of a third-party shopper executing a third-party shopper application. In some embodiments, the third-party shopper application is further configured to provide pick instructions/assistance for collecting items in a store, such as suggested picking order and in-store item locations.

In step 204, as the shopper picks items in the store, the system receives item identifiers for items in the customer order from the shopper. In some embodiments, the shopper may use the third-party shopper application and the camera on their mobile device to capture item identifiers (e.g. barcode) on items picked in the store. In some embodiments, the system may track the picked items based on the scans. In some embodiments, the shopper may select items in the order as being unavailable and/or out-of-stock. Once all items are either picked or marked as unavailable and/or out-of-stock, the system may determine that the picking is complete in step 205 and cause the shopper application to display instructions for completing the shopping trip and exiting the store. In some embodiments, the shopper may select an option in the shopper application user interface to indicate to the system that the picking is completed.

In some embodiments, the shopper is instructed by the user interface to approach a checkout terminal to use the bagging area of the checkout terminal to bag the picked items. The shopper may further be instructed to check in at the checkout terminal to pair with the checkout terminal by capturing a terminal identifier (e.g. by QR code scan or image scan) or providing an account identifier (e.g. by entering account information or displaying an identifier to be scanned). Upon receiving the terminal identifier from the third-party shopper device or the third-party shopper identifier from the checkout terminal, the system pairs the third-party shopper with the checkout terminal. The pairing of the shopper account with a checkout terminal may be received as a request for exit verification at the system. In some embodiments, the system further notifies the store upfront application that a checkout terminal check-in has been made by a shopper. In some embodiments, the user may request exit verification directly in the third-party shopper application.

In step 206, the system retrieves third-party shopper information associated with the third-party shopper from the third-party shopper database and determines whether to initiate an audit based at least on the shopper information stored in a third-party shopper database. In some embodiments, whether to initiate the audit process is determined based on the number of completed shopping trips by the third-party shopper, the length of third-party shopper account history, and/or past audit results associated with the third-party shopper. In some embodiments, whether to initiate the audit process is further determined based on the total cost of the customer order, costs of items in the customer order, and item types in the customer order. In some embodiments, the shopper and customer order information may be provided to a data analytics and predictive intelligence service and combined with data from other sources to determine whether the audit is required for a shopper.

If an audit is not determined to be required, the system generates an exit pass for the shopper, and in step 207, the exit pass is displayed on the shopper user device. In some embodiments, a notification is also sent to the store upfront application indicating that the shopper exiting the store is not selected for auditing. In some embodiments, the exit pass comprises a machine-readable optical code. An exit device is configured to provide a visual indication of whether the third-party shopper is verified to exit the retail store based on scanning the machine-readable optical code of the exit pass. For example, upon scanning a barcode on an exit pass, the system may determine whether the number encoded in the barcode matches an issued exit pass, whether the exit pass has expired, and whether the exit pass has been previously used. After the shopper exits the store, the shopper application may further display delivery instructions for the customer order (e.g. delivery address, customer instructions, navigation) in step 208.

If an audit is required, the system notifies a store associate in step 212. In some embodiments, the audit request notification may be displayed on a store user device such as an upfront device. A store associate may accept the audit request and approach the checkout terminal paired with the shopper in step 205 to perform the audit. In step 213, the store associate may scan items in the possession of the shopper (e.g. in cart or basket) with a store user device or the checkout terminal and provide the item identifiers to the system. The system may then compare the item identifiers of items in possession of the third-party shopper with items in the customer order. If the shopper passes the audit in step 214, a display pass is displayed as described with reference to step 207.

If the shopper fails the audit (i.e. unexpected items are present or picked items missing), options of corrective action are offered, such as purchasing the unexpected items, returning the unexpected items, or returning to picking. After the corrective action has been taken in step 215, an exit pass is displayed as described with reference to step 207. Otherwise, the shopper may elect to cancel the shopping trip in step 216.

In some embodiments, after step 208, the system may track the successful delivery of the customer order. In some embodiments, the payment methods provided by the customer for the customer order may be charged and processed by the retailer upon the successful completion/delivery of the customer order.

In some embodiments, the system may support multiple instances of steps 201-216 for a plurality of customer orders being fulfilled by a plurality of third-party shoppers.

Referring now to FIGS. 3A and 3B, a flow diagram of a process is shown. In some embodiments, the steps of FIGS. 3A and 3B may be performed by a shopper, a shopper application, an data analytics system, and an upfront application, and an SCO host system. In some embodiments, the shopper application may be displayed on a third-party shopper device and be supported by a central computer system described herein. In some embodiments, the upfront application may be executed on a store user device operated by a store employee/worker.

In step 311, the shopper completes a shopping trip for a customer order. In some embodiments, the shopper may indicate the completion of a shopping trip via user input in the shopping application. In some embodiments, the system may determine that the shopping trip is completed when all items in the customer order have been indicated as collected (e.g. scanned) or unavailable. In step 321, the shopper application displays a message to the shopper instructing the shopper to approach an SCO and scan a QR code at the SCO. In some embodiments, the QR code may be displayed on a display screen of the SCO. In step 312, the customer scans the QR code at the SCO. In step 331, in response to receiving the scanned QR code from the shopper, a data analytics component determines whether an audit is required. If an audit is not required, in step 322, the shopper application displays that audit is not required, and the shopper may proceed to continue with the delivery of the customer order in step 313. Notifications may be sent to the data analytics and the upfront application that the in-store shopping trip is completed.

If an audit is required, in step 323, the shopper application displays that the store is being notified to perform the audit. In step 341, the upfront application alerts the SCO host of the required audit. In step 351, a store associate uses the SCO to scan items in the cart of the shopper. In step 342, the system determines whether the scanned items are valid items for the order by comparing the scanned item identifiers with items in the order stored in the picked info database 325. If invalid items are detected, the upfront application displays an error in step 343, and the associate may remove the item from the cart in step 352. If there are more items in the cart, in step 344, the process returns to step 351 and the additional items are scanned. When scanning is completed, the system determines whether the shopper passed or failed the audit.

If the shopper passes the audit, the shopper application displays that the audit process is complete in step 326, and the shopper continues with delivery in step 314. In some embodiments, during steps 323 and 351, the system may determine whether the audit process has timed out, for example, if no store associate is available to perform the audit. If the audit process has timed out in step 324, the shopper may be notified and allowed to continue with delivery in step 314. In some embodiments, when the audit process timed out, a message is sent to the data analytics system and/or the upfront application informing them that the audit has been bypassed due to timeout.

If the shopper fails the audit in step 345, the shopper application displays that the audit failed in step 327 and the shopper is given the option to cancel the trip in step 315. If the shopper elects to continue, they may be instructed to make corrective action (e.g. purchase invalid items or return invalid items to a store associate) and continue with the delivery in step 315. Otherwise, the trip is canceled in step 328.

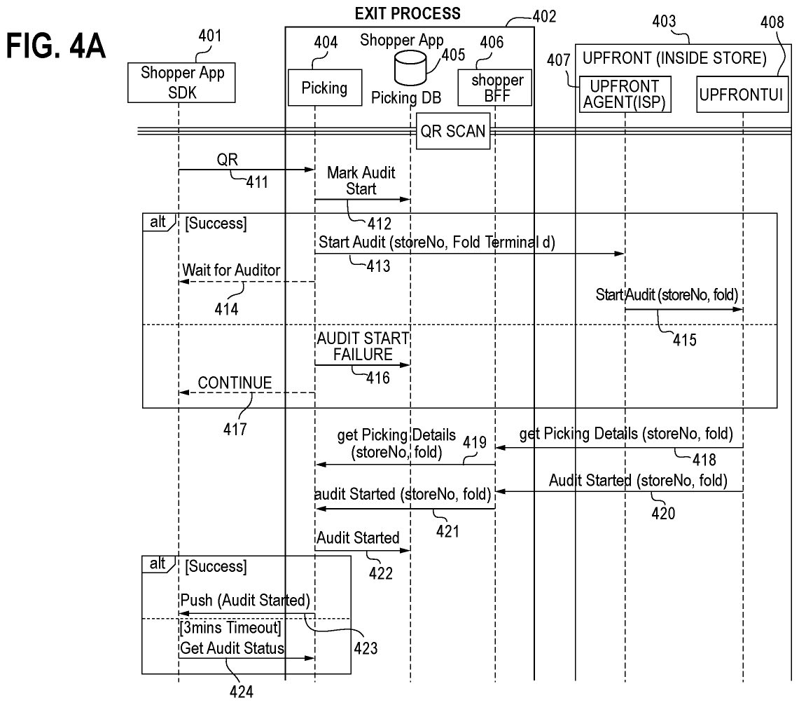

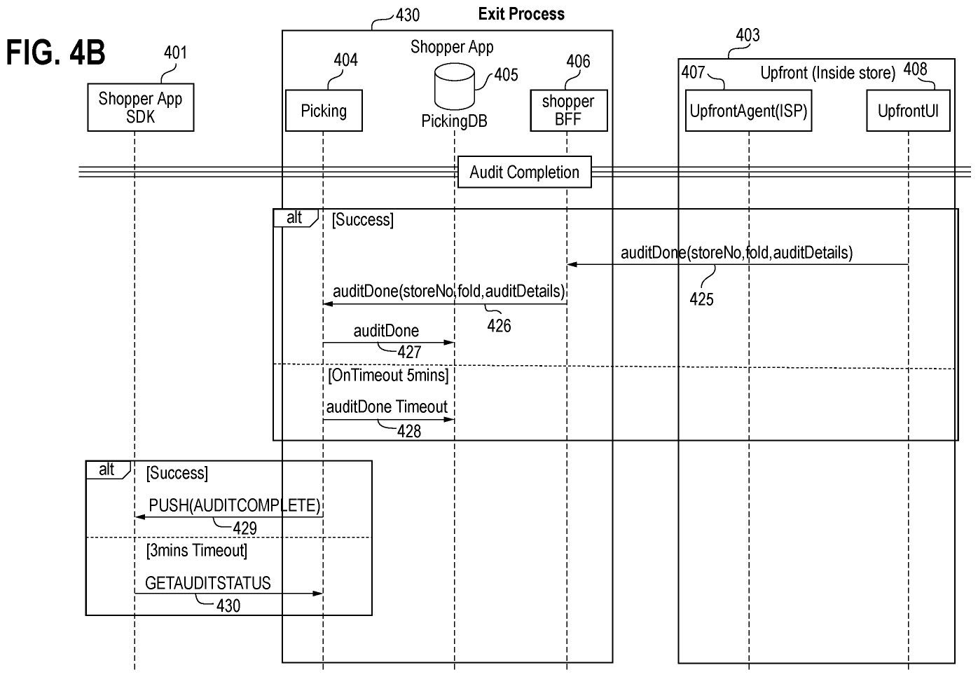

Referring now to FIGS. 4A and 4B, a process diagram of a third-party shopper exit verification process with push notification is shown. In some embodiments, the steps of FIGS. 4A and 4B may be performed by a shopper app SDK 401, a shopper application system 402, and an upfront system 403.

In step 411, the shopper app SDK 401 sends a scanned QR code to a picking module of the shopper application system 402. In some embodiments, the QR code may be displayed at a self-checkout terminal and may comprise a checkout terminal identifier and a store identifier. If auditing is required, the picking module 404 marks the start of the audit in an audit database 405 of the shopper application system 402 in step 412.

If the audit is successfully initiated, in step 413, the picking module 404 notifies the upfront system 403 of the start of the audit, forwarding the store number and the terminal number determined based on the QR code and the auditor account information. The picking module 404 further causes the shopper app SDK 401 to display a message to wait for an auditor in step 414. Upon receiving the start audit instruction, the upfront agent 407 of the upfront system 403 forwards the start audit message to the upfront user interface 408 in step 415.

Alternatively, if the audit process fails to start, in step 416, the picking module 404 records the information in the audit database 405 and notifies the shopper app SDK to continue with the exit process in step 417.

In step 418, the upfront user interface 408 requests for picking details from the shopper BFF (“backend for front end”) 406 in step 418 which forwards the request to the picking module 404 in step 419. When a store associate begins an audit, the upfront user interface 408 provides an audit started message to the shopper BFF 406 in step 420, which forwards the notification to the picking module 404 in step 421, which then records the information in the audit database 405 in step 422.

If the audit successfully starts, the shopper app SDK 401 is notified in step 423. Alternatively, if a predetermined time has passed (e.g. 3 minutes), and no audit start message has been received, the shopper app SDK 401 may request for audit status from the picking module 404 in step 424.

If the audit process successfully completes, the upfront user interface 408 notifies the shopper BFF 406 in step 425 which forwards the message to the picking module 404 in step 426. The picking module 404 then records the information in the audit database 405 in step 427. Alternatively, if more than a predetermined amount of time has passed from the start of the audit (e.g. 5 minutes), the picking module 404 may send a timeout message to terminate the audit to the audit database 405 in step 428.

If the audit successfully completes, the shopper app SDK is notified in step 429. Alternatively, if a predetermined time has passed (e.g. 3 minutes), and no audit complete message has been received, the shopper app SDK 401 may request for audit status from the picking module 404 in step 430.

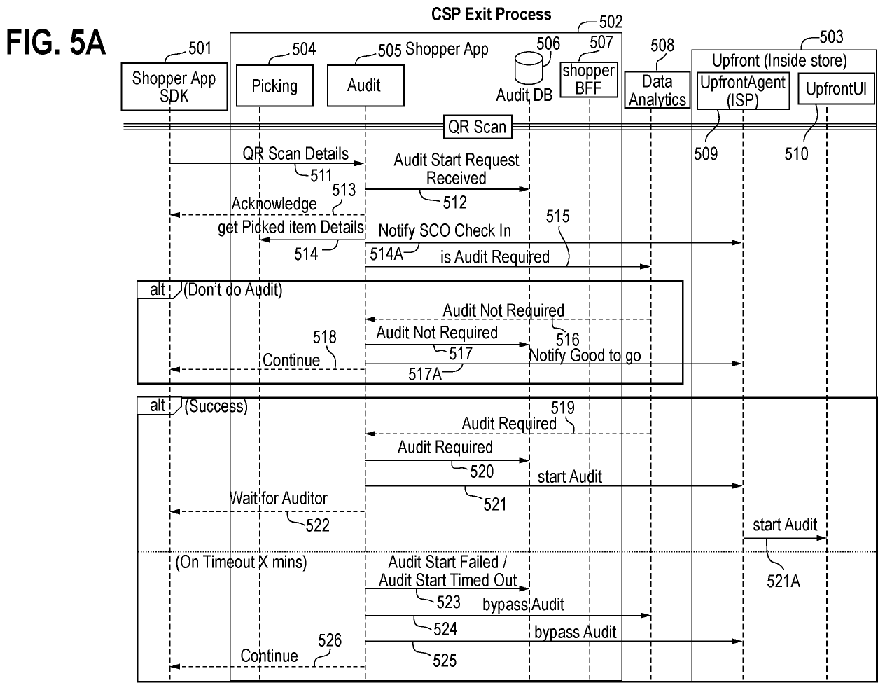

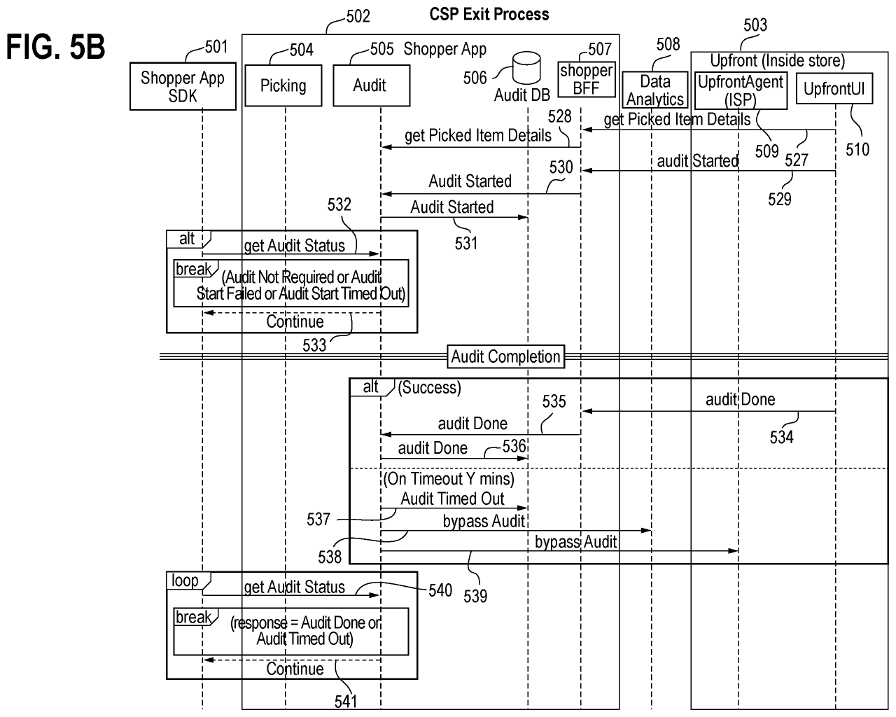

Referring now to FIGS. 5A and 5B, a process diagram of a third-party shopper exit verification process is shown. In some embodiments, the steps of FIGS. 5A and 5B may be performed by a shopper app SDK 501, a shopper application system 502, a data analytics system 508, and an upfront system 503.

In step 511, the shopper app SDK sends details from a QR scan at an SCO to the audit module 505 of the shopper application system 502. Step 511 may be performed to initiate the process when a shopper approaches an SCO at the end of a shopping trip. The audit module 505 sends the receipt of the audit-start request to the audit database 506 in step 512. The audit module 505 may further send an acknowledge message to the shopper app SDK 501 in step 513. In step 514, the audit module 505 retrieves picked item details from the picking module 504. In step 514A, the audit module 505 notifies the upfront agent 509 in step 514A. In step 515, the audit module 505 sends the picked item information and shopper information to the data analytics system 508 to determine whether an audit is required. If the data analytics system 508 indicates that an audit is not required in step 516, the response is recorded in the audit database 506 in step 517 and the upfront agent 509 is notified that the shopper is good to go in step 517A. The shopper app SDK 501 is notified to continue in step 518.

If the data analytics system 508 indicates that an audit is required in step 519, the response is recorded in the audit database 506 in step 520. The audit module 505 notifies the upfront agent 509 to start the audit in step 521. The start audit message is then sent from the upfront agent 509 to the upfront user interface 510 in step 521A. The shopper APP SDK 501 is also notified to wait for the auditor in step 522.

Alternatively, if a predetermined amount of time passes after step 515, the audit module 505 may record that the audit start fails and/or timed out to the audit BFF DB in step 523. The audit module 505 further notifies the data analytics system 508 and the upfront agent to bypass the audit in step 524 and step 525 respectively. The audit module 505 further notifies the shopper app SDK 501 to continue in step 526.

If an audit is required, the upfront UI 510 requests for picked item details from the shopper BFF 507 in step 527, which forwards the request to the audit module 505 in step 528. In step 529, the upfront UI 510 notifies the shopper BFF 507 that the audit has started. The audit-start message is forwarded to the audit module 505 in step 530 and is recorded in the audit database 506 in step 531.

In some embodiments, the shopper app SDK 501 may periodically request audit status information from the audit module 505 in step 532. If an audit is not required, has failed, or has timed out, the audit module 505 will instruct the shopper app SDK 501 to continue to with the exit process without completing an audit process in step 533.

When the audit process is complete (e.g. the store associate has verified that the content of the shopper's shopping basket matches the picked item list), an audit done message is sent from the upfront UI 510 to the shopper BFF 507 in step 534, which forwards the message to the audit module 505 in step 535. The audit complete information is stored in the audit database 506 in step 536. Alternatively, if the no audit done message is received after a set amount of time, the audit module 505 records the information in the audit database 506 in step 537 and notifies the data analytics system 508 and the upfront agent 509 to bypass the audit in step 538 and step 539 respectively.

In some embodiments, prior to the completion of the audit, the shopper app SDK 501 may continue to periodically request audit status information from the audit module 505 in step 540 and if the audit is done or has timed out, the audit module 505 will instruct the shopper app SDK 501 to continue with the exit process in step 541.

Next referring to FIGS. 6A-6G, 7A-7F, 8A-8B, and 9A-9C, example displays of a user interface for a third-party shopper application are shown. The information, user interface options, and designs in FIGS. 6A-6G, 7A-7F, 8A-8B, and 9A-9C are shown as examples only. Various user interface designs and functions may be implemented with the systems and methods described herein.

In FIG. 6A, the display indicates that shopping is finished. In some embodiments, the display in FIG. 6A may be shown to a shopper when all items in a customer order have been picked or marked as unavailable/out of stock. FIG. 6B provides instructions for the self-checkout process for a third-party shopper. Specifically, the shopper is instructed to scan a QR code at the register, keep their personal items separate from the customer order, wait for a cart check if required, and request assistance if needed. When “scan QR code” is elected in FIG. 6B, the user device's camera may be turned on and used to capture a QR code at an SCO. FIG. 6B shows bagging instructions for food items, cold items, and anti-theft devices.

After scanning a QR code at an SCO or otherwise requesting to exit the store, if no audit is required, the shopper is shown FIG. 6D as approval to exit. In step 6E, if an exit pass check is required, information for using the exit pass is shown. FIG. 6F shows an example of an exit pass. The exit pass includes a scannable bar code 602 and information about the order such as the names of the shopper, the customer, the total cost of the order, and the number of items in the order. In some embodiments, the exit pass may further include an order type indicator 601 that allows an associate to distinguish third-party shopper exit passes from exit passes associated with other types of purchases (e.g. in-store customer purchases). The exit pass further includes an option to view order summary 603. Selecting view order summary 603 may bring up details of the items in the order such as those shown in FIG. 6G.

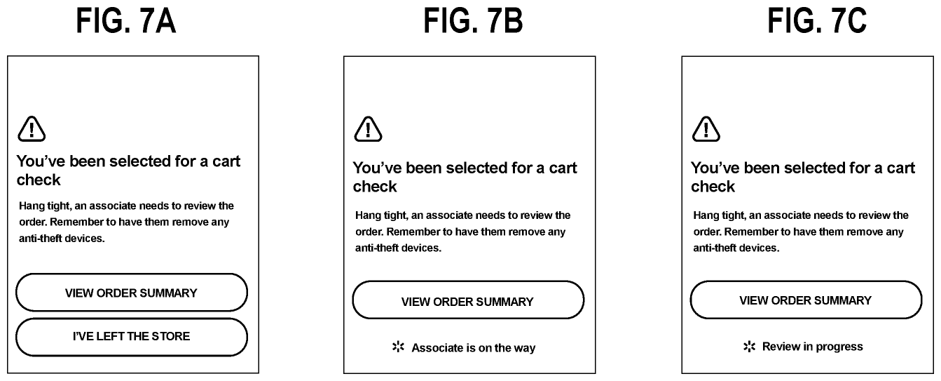

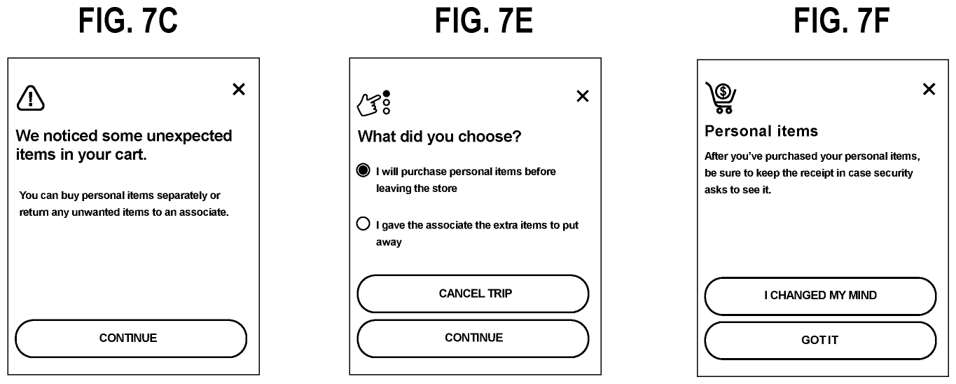

If an audit process is required, the third-party shopper application may display FIG. 7A, notifying the shopper that they have been selected for a cart check. When an associate accepts the audit task via a store user device, the display updates to show that an “associate is on the way” as shown in FIG. 7B. When the associate begins to review the items (e.g. by checking in at the SCO or by starting to scan the items), the display may be updated to show “review in progress” as shown in FIG. 7C. If the shopper passes the audit, FIGS. 6D-6G may be displayed and the shopper may proceed to exit using an exit pass.

If unexpected items are detected, FIG. 7D may be displayed notifying the shopper. In FIG. 7E, options for handling unexpected items are presented. Specifically, the shopper may purchase unexpected items, hand the items to an associate, or cancel the trip. If purchasing the unexpected items is selected in FIG. 7E, FIG. 7F may be displayed providing instructions for exiting the store with personal items.

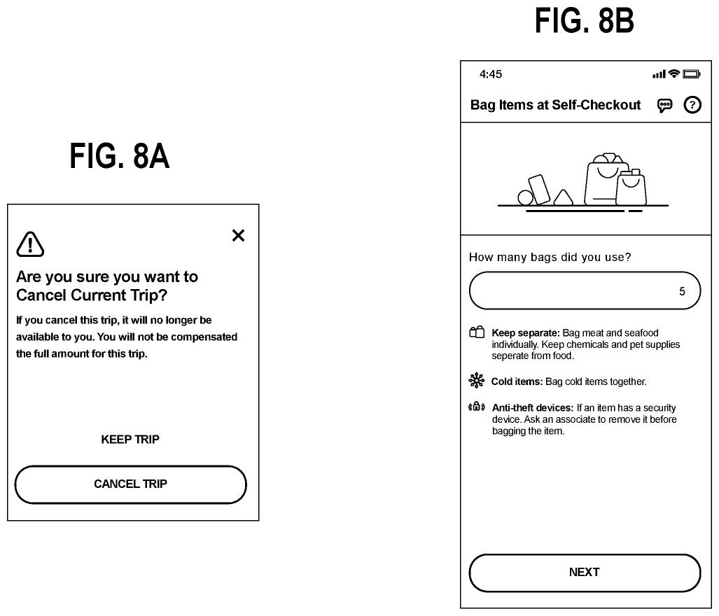

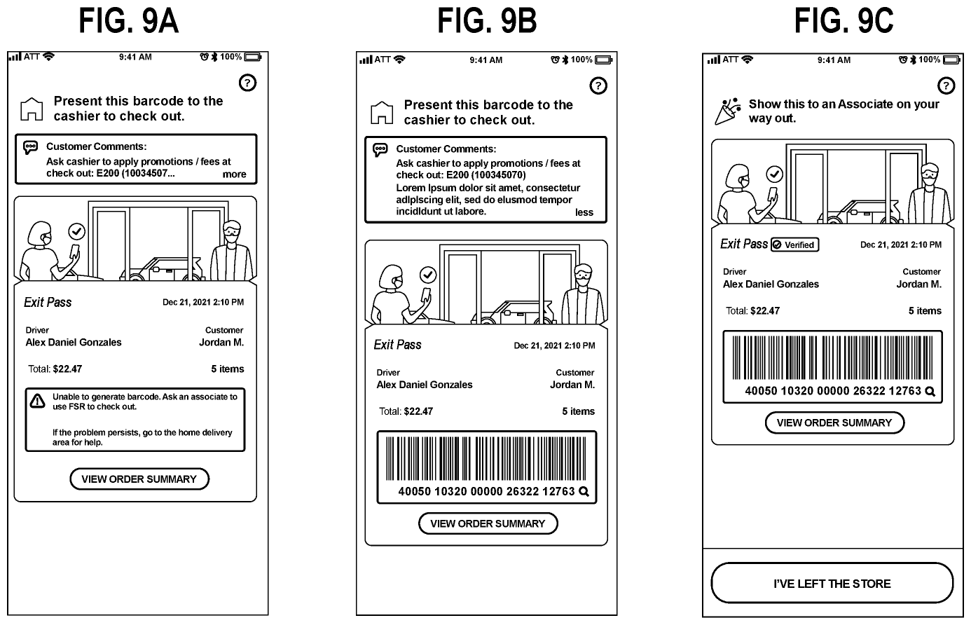

If “cancel trip” is selected at any point, FIG. 8A may be displayed for confirmation. FIG. 8B shows an alternate version of FIG. 6B which requires the shopper to enter the number of bags used for stores that are required to record and/or charge for used bags. FIG. 9A-9C are illustrations of alternate displays of an exit pass. FIG. 9A shows an error in generating a barcode, and the shopper is instructed to ask an associate for assistant to complete the checkout. FIG. 9B shows an exit pass that also displays customer comments for the order. FIG. 9C shows an exit pass without additional exit instructions.

In some embodiments, a system for third-party shopper exit verification comprises a store user device, a network interface, a third-party shopper database, and a central computer system. The central computer system comprising a control circuit configured to provide, via the network interface to a third-party shopper device of a third-party shopper executing a third-party shopper application, items in a customer order to be collected by a third-party shopper from a retail store; detect a completion of a shopping trip for the customer order; retrieve third-party shopper information associated with the third-party shopper from the third-party shopper database; and determine whether to initiate an audit process based at least on the third-party shopper information. In the event that the audit process is required, the control circuit is configured to cause an audit request to display on the store user device and determine whether the third-party shopper passes the audit process based on comparing item identifiers of items in possession of the third-party shopper with items in the customer order. In the event that the audit process is not required or the third-party shopper passes the audit process, the control circuit is configured to cause an exit instruction to be displayed on the third-party shopper device.

In some embodiments, a method for third-party shopper exit verification includes: providing, from a central computer system via a network interface to a third-party shopper device of a third-party shopper executing a third-party shopper application, items in a customer order to be collected by a third-party shopper from a retail store; detecting a completion of a shopping trip for the customer order; retrieving third-party shopper information associated with the third-party shopper from a third-party shopper database; and determining whether to initiate an audit process based at least on the third-party shopper information; in the event that the audit process is required: causing an audit request to display on a store user device; and determining whether the third-party shopper passes the audit process based on comparing item identifiers of items in possession of the third-party shopper with items in the customer order; in the event that the audit process is not required or the third-party shopper passes the audit process: causing an exit instruction to be displayed on the third-party shopper device.

In some embodiments, an apparatus for third-party shopper exit verification includes a non-transitory storage medium storing a set of computer readable instructions; and a control circuit configured to execute the set of computer readable instructions which cause the control circuit to: provide, from a central computer system via a network interface to a third-party shopper device of a third-party shopper executing a third-party shopper application, items in a customer order to be collected by a third-party shopper from a retail store; detect a completion of a shopping trip for the customer order; retrieve third-party shopper information associated with the third-party shopper from a third-party shopper database; and determine whether to initiate an audit process based at least on the third-party shopper information; in the event that the audit process is required: cause an audit request to display on a store user device; and determine whether the third-party shopper passes the audit process based on comparing item identifiers of items in possession of the third-party shopper with items in the customer order; in the event that the audit process is not required or the third-party shopper passes the audit process: cause an exit instruction to be displayed on the third-party shopper device.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

What is claimed is:

1. A system for third-party shopper exit verification, the system comprises:
a store user device;
a network interface;
a third-party shopper database; and
a central computer system, the central computer system comprising a control circuit configured to:
provide, via the network interface to a third-party shopper device of a third-party shopper executing a third-party shopper application, items in a customer order to be collected by a third-party shopper from a retail store;
detect a completion of a shopping trip for the customer order;
retrieve third-party shopper information associated with the third-party shopper from the third-party shopper database; and
determine whether to initiate an audit process based at least on the third-party shopper information;
in the event that the audit process is required:
cause an audit request to display on the store user device; and
determine whether the third-party shopper passes the audit process based on comparing item identifiers of items in possession of the third-party shopper with items in the customer order; and
in the event that the audit process is not required or the third-party shopper passes the audit process:
cause an exit instruction to be displayed on the third-party shopper device.

2. The system of claim 1, further comprises:
a self-checkout terminal,
wherein the completion of the shopping trip is detected based on receiving a terminal identifier associated with the self-checkout terminal from the third-party shopper device.

3. The system of claim 2, wherein the self-checkout terminal is configured to display the terminal identifier as a machine-readable optical code scannable by the third-party shopper device.

4. The system of claim 2, wherein the self-checkout terminal comprises an optical code scanner for obtaining the item identifiers of items in possession of the third-party shopper.

5. The system of claim 1, wherein the central computer system is further configured to:
provide a shopping list of items associated with the customer order to the third-party shopper; and
receive, from the third-party shopper application, item identifiers associated with items on the item list;
wherein the completion of the shopping trip is detected based on the item identifiers received from the third-party shopper application.

6. The system of claim 1, wherein whether to initiate the audit process is determined based on a number of completed shopping trips by the third-party shopper, a length of third-party shopper account history, and/or past audit results associated with the third-party shopper.

7. The system of claim 1, wherein whether to initiate the audit process is further determined based on a total cost of the customer order, costs of items in the customer order, and item types in the customer order.

8. The system of claim 1, wherein the exit instruction comprises an exit pass including a machine-readable optical code displayed on the third-party shopper device.

9. The system of claim 8, further comprises:
an exit device with an optical code scanner, wherein the exit device is configured to provide a visual indication of whether the third-party shopper is verified to exit the retail store based on scanning the machine-readable optical code of the exit pass.

10. The system of claim 1, wherein the customer order is a pre-paid order or a pre-authorized payment order placed by a customer other than the third-party shopper; and
wherein the central computer system is further configured to cause the third-party shopper device to display delivery instructions for the customer order.

11. A method for third-party shopper exit verification, the method comprises:
providing, from a central computer system via a network interface to a third-party shopper device of a third-party shopper executing a third-party shopper application, items in a customer order to be collected by a third-party shopper from a retail store;
detecting a completion of a shopping trip for the customer order;
retrieving third-party shopper information associated with the third-party shopper from a third-party shopper database; and
determining whether to initiate an audit process based at least on the third-party shopper information;
in the event that the audit process is required:
causing an audit request to display on a store user device; and
determining whether the third-party shopper passes the audit process based on comparing item identifiers of items in possession of the third-party shopper with items in the customer order;
in the event that the audit process is not required or the third-party shopper passes the audit process:
causing an exit instruction to be displayed on the third-party shopper device.

12. The method of claim 11, further comprises:
wherein the completion of the shopping trip is detected based on receiving a terminal identifier associated with a self-checkout terminal from the third-party shopper device.

13. The method of claim 12, wherein the self-checkout terminal is configured to display the terminal identifier as a machine-readable optical code scannable by the third-party shopper device.

14. The method of claim 12, wherein the self-checkout terminal comprises an optical code scanner for obtaining the item identifiers of items in possession of the third-party shopper.

15. The method of claim 11, further comprises
providing a shopping list of items associated with the customer order to the third-party shopper; and
receiving, from the third-party shopper application, item identifiers associated with items on the item list;
wherein the completion of the shopping trip is detected based on the item identifiers received from the third-party shopper application.

16. The method of claim 11, wherein whether to initiate the audit process is determined based on a number of completed shopping trips by the third-party shopper, a length of third-party shopper account history, and/or past audit results associated with the third-party shopper.

17. The method of claim 11, wherein whether to initiate the audit process is further determined based on a total cost of the customer order, costs of items in the customer order, and item types in the customer order.

18. The method of claim 11, wherein the exit instruction comprises an exit pass including a machine-readable optical code displayed on the third-party shopper device.

19. The method of claim 18, further comprises:
providing, at an exit device, a visual indication of whether a third-party shopper is verified to exit the retail store based on scanning the machine-readable optical code of the exit pass.

20. An apparatus for third-party shopper exit verification comprising:
a non-transitory storage medium storing a set of computer readable instructions; and
a control circuit configured to execute the set of computer readable instructions which cause the control circuit to:
provide, from a central computer system via a network interface to a third-party shopper device of a third-party shopper executing a third-party shopper application, items in a customer order to be collected by a third-party shopper from a retail store;
detect a completion of a shopping trip for the customer order;
retrieve third-party shopper information associated with the third-party shopper from a third-party shopper database; and
determine whether to initiate an audit process based at least on the third-party shopper information;
in the event that the audit process is required:
cause an audit request to display on a store user device; and
determine whether the third-party shopper passes the audit process based on comparing item identifiers of items in possession of the third-party shopper with items in the customer order;
in the event that the audit process is not required or the third-party shopper passes the audit process:
cause an exit instruction to be displayed on the third-party shopper device.
